(19) United States
(12) Patent Application Publication
(10) Pub. No.: US 2010/0306437 A1
(43) Pub. Date: Dec. 2, 2010

(54) METHOD AND APPARATUS TO SELECTIVELY EXTEND AN EMBEDDED MICROPROCESSOR BUS THROUGH A DIFFERENT EXTERNAL BUS

(76) Inventors: Matthew W. Heath, Hillsboro, OR (US); Mohan K. Nair, Portland, OR (US); Guadalupe J. Garcia, Chandler, AZ (US); Bibbin Chacko, Chandler, AZ (US); Timothy F. Waite, Chandler, AZ (US); Mark A. Yarch, Chandler, AZ (US); Hang T. Nguyen, Tempe, AZ (US); Saiyid Al-Mahmood, Hillsboro, OR (US); Lyonel Renaud, Queen Creek, AZ (US); Ganesh Kondapuram, Gilbert, AZ (US); Richard L. Stout, Hillsboro, OR (US)

Correspondence Address: David Guglielmi;c/o CPA Global, P.O. Box 52050, Minneapolis, MN, 55402, US

(21) Appl. No.: 12/471,616

(22) Filed: May 26, 2009

(51) Int. Cl. G06F 13/14

(52) U.S. Cl. 710/305

(57) ABSTRACT

A method and apparatus to selectively extend an embedded microprocessor bus through a different external bus are generally presented. In this regard, an apparatus is introduced comprising a first high speed serializer/deserializer (SERDES) bus internal to an integrated circuit device to couple an embedded microprocessor with an embedded component, a second high speed SERDES bus different from the first bus to couple the embedded component with an external interface of the integrated circuit device, and extension circuitry to selectively bypass the embedded component and extend the first bus to function at the external interface over a physical layer of the second bus. Other embodiments are also described and claimed.

### FIELD

Embodiments of the present invention may relate to the field of microprocessor design and testing, and more specifically to a method and apparatus to selectively extend an embedded microprocessor bus through a different external bus.

### BACKGROUND

With increased integration in integrated circuit devices, microprocessors are becoming embedded with other components into chip packages that are colloquially referred to as a system on a chip (SOC). However, with the embedding of microprocessors, testing of the device can become complicated as busses that were once externally accessible to a tester are only available internal to the device. While prior art solutions include wires and muxes to selectively extend a bus, this is not an option to functionally extend one high speed serializer/deserializer (SERDES) bus through a physical layer of another SERDES bus.

### BRIEF DESCRIPTION OF THE DRAWINGS

Embodiments of the present invention may become apparent from the following detailed description of arrangements, example embodiments, and the claims when read in connection with the accompanying drawings. While the foregoing and following written and illustrated disclosure focuses on disclosing arrangements and example embodiments of the invention, it should be clearly understood that the same is by way of illustration and example only and embodiments of the invention are not limited thereto.

The following represents brief descriptions of the drawings in which like reference numerals represent like elements and wherein:

FIG. 1 is a block diagram of an example electronic appliance suitable for implementing an apparatus to selectively extend an embedded microprocessor bus through a different external bus, in accordance with one example embodiment of the invention;

FIG. 2 is a block diagram of an example integrated circuit device including an apparatus to selectively extend an embedded microprocessor bus through a different external bus, in accordance with one example embodiment of the invention;

FIG. 3 is a block diagram of an example logical implementation of an apparatus to selectively extend an embedded microprocessor bus through a different external bus, in accordance with one example embodiment of the invention; and

FIG. 4 is a block diagram of an example implementation of a physical layer interface configurable to function as different buses, in accordance with one example embodiment of the invention.

### DETAILED DESCRIPTION

In the following description, for purposes of explanation, numerous specific details are set forth in order to provide a thorough understanding of the invention. It will be apparent, however, to one skilled in the art that embodiments of the invention can be practiced without these specific details. In other instances, structures and devices are shown in block diagram form in order to avoid obscuring the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

FIG. 1 is a block diagram of an example electronic appliance suitable for implementing an apparatus to selectively extend an embedded microprocessor bus through a different external bus, in accordance with one example embodiment of the invention. Electronic appliance 100 is intended to represent any of a wide variety of traditional and non-traditional electronic appliances, laptops, cell phones, wireless communication subscriber units, personal digital assistants, or any electric appliance that would benefit from the teachings of the present invention. In accordance with the illustrated example embodiment, electronic appliance 100 may include one or more of microprocessor 102, memory controller 104, system memory 106, input/output controller 108, network controller 110, input/output device(s) 112, integrated package 114, first bus 116, and second bus 118 coupled as shown in FIG. 1.

Microprocessor 102 may represent any of a wide variety of control logic including, but not limited to one or more of a microprocessor, a programmable logic device (PLD), programmable logic array (PLA), application specific integrated circuit (ASIC), a microcontroller, and the like, although the present invention is not limited in this respect. In one embodiment, microprocessor 102 is an Intel® compatible processor. Microprocessor 102 may have an instruction set containing a plurality of machine level instructions that may be invoked, for example by an application or operating system.

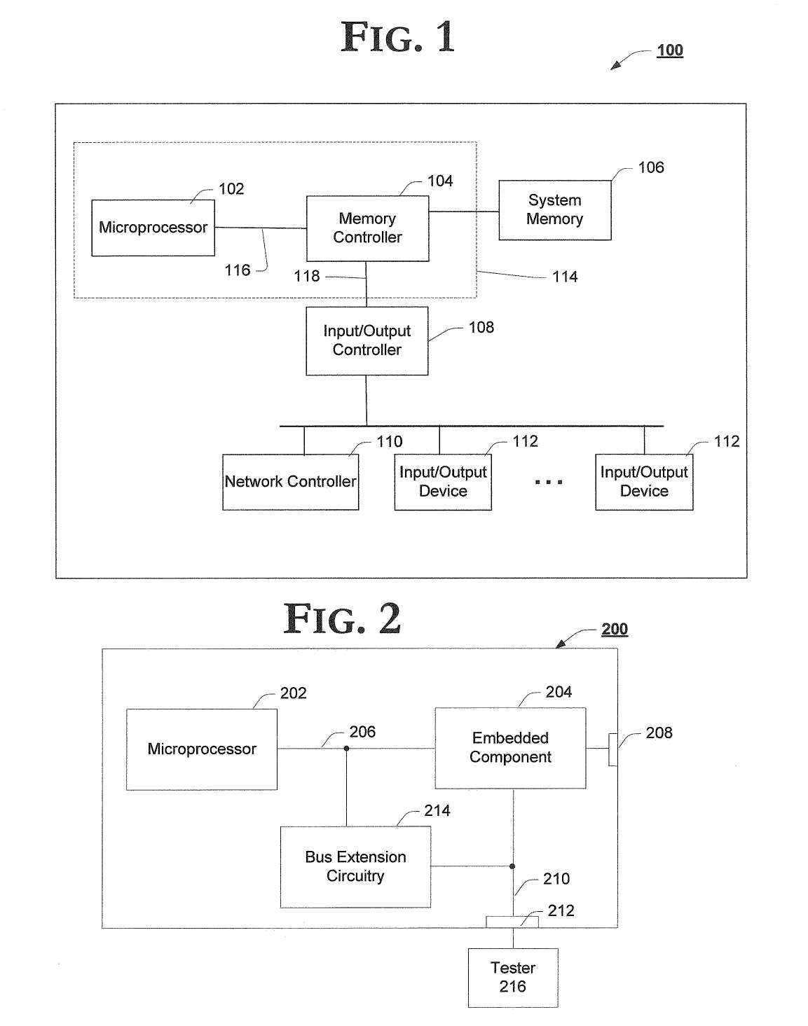

Memory controller 104 may represent any type of chipset or control logic that interfaces system memory 106 with the other components of electronic appliance 100. In one embodiment, first bus 116, which communicatively couples microprocessor 102 and memory controller 104, may be a high speed/frequency serial link such as Intel® QuickPath Interconnect. In another embodiment, first bus 116 may comply with the HyperTransport Specification, Revision 3.1, HyperTransport Technology Consortium, released Aug. 18, 2008 and/or other revisions. In another embodiment, memory controller 104 may be incorporated along with microprocessor 102 into integrated package 114 with first bus 116 embedded therein. As described in more detail with reference to FIG. 2, second bus 118 may provide an external interface for integrated package 114. In one embodiment, second bus 118 is of a different technology or specification than first bus 116. While shown as including microprocessor 102 and memory controller 104, integrated package 114 may include different or other components, such as I/O controller 108, without deviating from the scope of the invention.

System memory 106 may represent any type of memory device(s) used to store data and instructions that may have been or will be used by microprocessor 102. Typically, though the invention is not limited in this respect, system memory 106 will consist of dynamic random access memory (DRAM). In one embodiment, system memory 106 may consist of Rambus DRAM (RDRAM). In another embodiment, system memory 106 may consist of double data rate synchronous DRAM (DDRSDRAM).

Input/output (I/O) controller 108 may represent any type of chipset or control logic that interfaces I/O device(s) 112 with the other components of electronic appliance 100. In one embodiment, I/O controller 108 may be referred to as a south bridge. In another embodiment, I/O controller 108 may comply with the Peripheral Component Interconnect (PCI) Express™ Base Specification, Revision 1.0a, PCI Special Interest Group, released Apr. 15, 2003 and/or other revisions.

Network controller 110 may represent any type of device that allows electronic appliance 100 to communicate with other electronic appliances or devices. In one embodiment, network controller 110 may comply with a The Institute of Electrical and Electronics Engineers, Inc. (IEEE) 802.11b standard (approved Sep. 16, 1999, supplement to ANSI/IEEE Std 802.11, 1999 Edition). In another embodiment, network controller 110 may be an Ethernet network interface card.

Input/output (I/O) device(s) 112 may represent any type of device, peripheral or component that provides input to or processes output from electronic appliance 100.

FIG. 2 is a block diagram of an example integrated circuit device including an apparatus to selectively extend an embedded microprocessor bus through a different external bus, in accordance with one example embodiment of the invention. Integrated package 200 may include embedded microprocessor 202, embedded component 204, first bus 206, memory interface 208, second bus 210, external interface 212, and bus extension circuitry 214, as shown. While shown as integrating a microprocessor and one embedded component, integrated package 200 may integrate other and/or additional components. Embedded component 204 may represent a memory controller, an I/O controller, a graphics controller, and/or any other component that could be integrated into a package.

In this example, first bus 206 is a high speed serializer/deserializer (SERDES) bus internal to integrated package 200, which may represent a system on chip (SOC), and communicatively couples embedded microprocessor 202 with embedded component 204. Also, in this example, second bus 210 is a high speed SERDES bus of a different protocol from first bus 206 and couples embedded component 204 with external interface 212. In some embodiments, integrated package 200 represents a single integrated circuit die and first bus 206 may not be clearly distinguishable. In other embodiments, microprocessor 202 and embedded component 204 are separate integrated circuit dice on integrated package 200.

In this example, bus extension circuitry 214 has the ability to selectively extend first bus 206 from embedded microprocessor 202 to external interface 212. As part of an example method for extending first bus 206 from embedded microprocessor 202 to external interface 212, for example during a testing method to validate functionality of embedded microprocessor 202 and first bus 206, bus extension circuitry 214 may be selectively enabled.

In one embodiment, tester 216 may be coupled with external interface 212 to functionally test microprocessor 202, while in other embodiments other components/systems may be coupled with external interface 212. In one embodiment, tester 216 is only capable of communicating in the protocol of first bus 206 and extension circuitry 214 includes circuitry to selectively bypass embedded component 204 and extend first bus 206 to function at external interface 212 over a physical layer of second bus 210. In another embodiment, when extension circuitry 214 is enabled, external interface 212 has its communication protocol translated from that of second bus 210 to that of first bus 206.

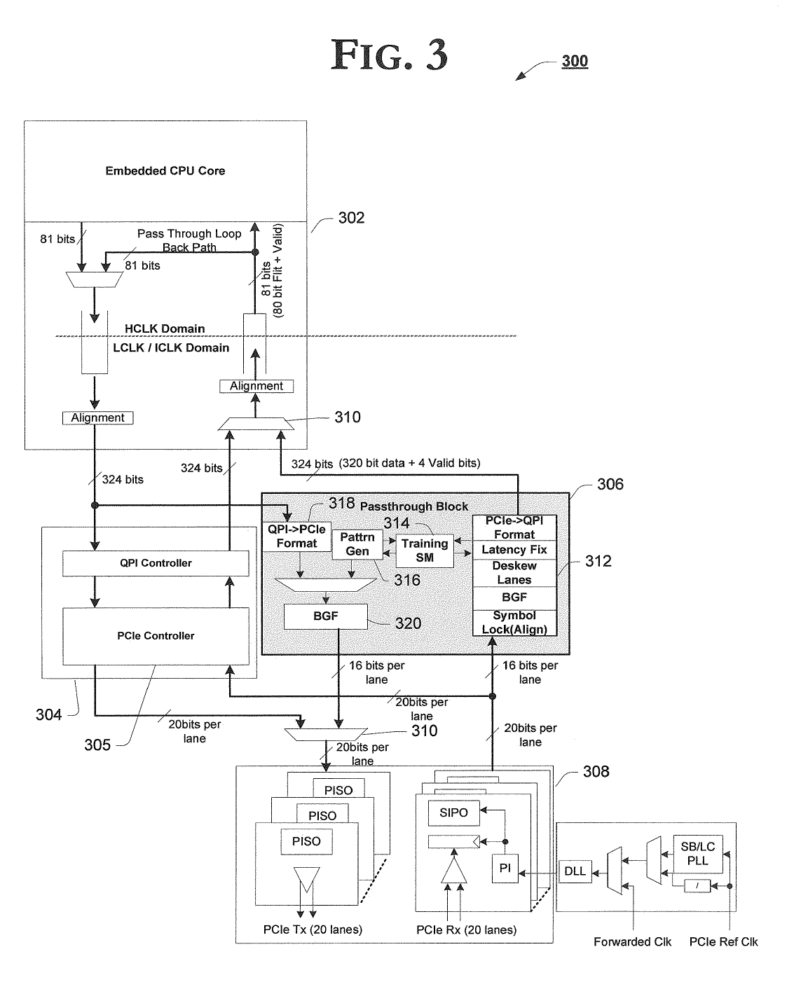

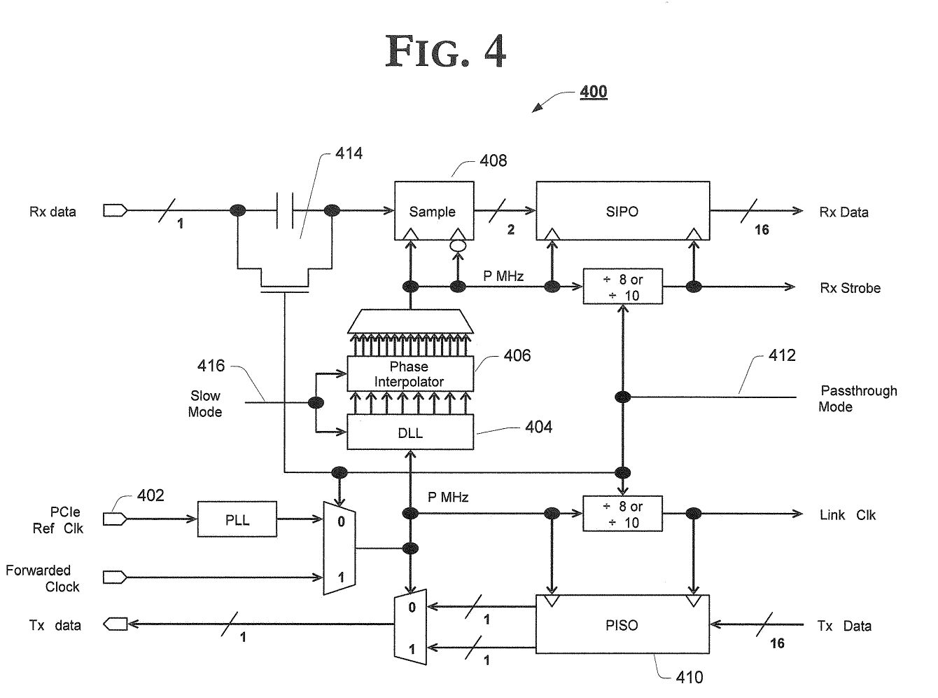

FIG. 3 is a block diagram of an example logical implementation of an apparatus to selectively extend an embedded microprocessor bus through a different external bus, in accordance with one example embodiment of the invention. Logic 300 may include microprocessor logic 302, embedded controller logic 304 (which includes PCI Express [PCIe] controller 305), passthrough logic 306 and physical layer logic 308 coupled as shown in FIG. 3. In this example, passthrough logic 306 may be selectively enabled through multiplexers 310 to communicatively couple microprocessor logic 302 with physical layer logic 308, thereby bypassing PCIe controller 305.

In this example, a first bus coupling microprocessor logic 302 with PCIe controller 305 represents a QuickPath Interconnect (QPI) bus, while a second bus coupling PCIe controller 305 with physical layer logic 308 represents a PCI Express (PCIe) bus. In this example, differences between the first bus and the second bus include: the physical width of their data buses; the maximum operating frequency supported by their synchronous logic; the use of a forwarded clock or an embedded clock; the format of information packets transmitted along them, including the arrangement of bytes in series or parallel; DC or AC coupling of the interconnect; and the existence or lack of a low-frequency mode of operation. Passthrough logic 306, along with changes to the PCIe Phase Lock Loop (PLL) logic and the PCIe parallel-in-serial-out (PISO) and serial-in-parallel-out (SIPO) logic, for example as shown in FIG. 4, allows for testing a microprocessor core and uncore using existing test vectors.

Passthrough logic 306 may include receive logic 312, training state machine 314 and pattern generator 316, transmit logic 318, and transmit FIFO 320, as shown.

With the PCIe interface modified to behave like a QPI interface, passthrough logic 306 is used to route QPI packets around the PCIe controller 305 to the microprocessor logic 302. In one example, passthrough logic 306 must first train the PCIe interface with the physical layer logic 308 using training state machine 314 and pattern generator 316 by sending a sub-set of training patterns defined by the QPI Specification on PCIe Tx to the tester while the tester is sending training patterns into receive logic 312. This training sets up transmit and receive logic of passthrough logic 306 to be in sync with each other and with the tester.

This training process performs bit lock (positioning sampling strobes in the centers of data eyes), symbol lock (identification of byte boundaries in serial data streams), deskew (alignment of corresponding bits in different lanes), synchronization (with a bubble generator FIFO, or BGF) and latency fixing (alignment of packet headers to a deterministically-timed event despite component and tester variation).

After training, the passthrough logic 306 behaves like a pair of constant-latency FIFO buffers with a static parallel-to-serial transfer function.

FIG. 4 is a block diagram of an example implementation of a physical layer interface configurable to function as different buses, in accordance with one example embodiment of the invention. Physical layer 400 includes forwarded clock 402, delay lock loop (DLL) 404, phase interpolator 406, SIPO block 408, PISO block 410, passthrough mode input 412, AC capacitance bypass 414, and slow mode input 416.

In this example, passthrough mode input 412 controls whether the physical layer behaves like a PCIe interface or a QPI interface. When passthrough mode is selected, the forwarded clock 402 is used instead of an on-chip PLL as a clock source for the physical layer. This clock source, together with a circuit which divides the clock by 8 in passthrough mode and by 10 otherwise, is used to clock PISO 410. The clock source is also used, in conjunction with DLL 404 and phase interpolator 406, to sample incoming Rx data, and, together with another clock divider circuit, to clock SIPO 408. Selecting passthrough mode also bypasses the AC coupling capacitor on the Rx data bus. When slow mode 416 is selected, the DLL 404 and phase interpolator 406 are modified so that a low-frequency forwarded clock 402 can propagate through them.

Although embodiments of the present invention have been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. An apparatus comprising:
a first high speed serializer/deserializer (SERDES) bus internal to an integrated circuit device to couple an embedded microprocessor with an embedded component;
a second high speed SERDES bus different from the first bus to couple the embedded component with an external interface of the integrated circuit device; and
extension circuitry to selectively bypass the embedded component and extend the first bus to function at the external interface over a physical layer of the second bus.

2. The apparatus of claim 1, wherein the first bus comprises a forwarded clock and wherein the second bus comprises an embedded clock.

3. The apparatus of claim 1, wherein the embedded microprocessor and the embedded component are part of a same integrated circuit die.

4. The apparatus of claim 1, wherein the embedded component comprises a memory controller.

5. The apparatus of claim 1, wherein the extension circuitry comprises a training state machine and pattern generator to calibrate a tester coupled with the external interface.

6. The apparatus of claim 1, wherein a physical layer interface of the second bus comprises a phase interpolator selectable to enable a slow mode of operation.

7. The apparatus of claim 1, wherein the extension circuitry comprises latency fixing logic to align a plurality of data lanes to a reference time.

8. The apparatus of claim 1, wherein a physical layer interface of the second bus comprises one or more AC coupling capacitor(s) adapted to be bypassed to accommodate packets adhering to a protocol of the first bus.

9. An apparatus comprising:
means for communicatively coupling an embedded microprocessor with an embedded component internal to an integrated circuit device through a first high speed serial bus;
means for communicatively coupling the embedded component with an external interface of the integrated circuit device through a second high speed serial bus; and
means for selectively bypassing the embedded component and extending the first high speed serial bus to function at the external interface over a physical layer of the second bus.

10. The apparatus of claim 9, wherein the embedded component comprises an integrated input/output controller.

11. The apparatus of claim 9, wherein the means for selectively communicatively coupling the embedded microprocessor with the external interface and bypassing the embedded component comprises a training state machine and pattern generator.

12. The apparatus of claim 9, wherein the means for selectively communicatively coupling the embedded microprocessor with the external interface and bypassing the embedded component comprises a phase interpolator selectable to enable a slow mode of operation.

13. The apparatus of claim 9, wherein the means for selectively communicatively coupling the embedded microprocessor with the external interface and bypassing the embedded component comprises latency fixing logic to align a plurality of data lanes to a reference time.

14. The apparatus of claim 9, wherein the means for selectively communicatively coupling the embedded microprocessor with the external interface and bypassing the embedded component comprises one or more AC coupling capacitor(s) adapted to be bypassed to accommodate packets adhering to a protocol of the first bus.

15. A system comprising:
a network controller;
a memory controller; and
a microprocessor, wherein the microprocessor and the memory controller are embedded in an integrated circuit device comprising:
a first high speed serializer/deserializer (SERDES) bus internal to the integrated circuit device to couple the embedded microprocessor with the embedded memory controller;
a second high speed SERDES bus different from the first bus to couple the embedded memory controller with an external interface of the integrated circuit device; and
extension circuitry to selectively bypass the embedded memory controller and extend the first bus to function at the external interface over a physical layer of the second bus.

16. The system of claim 15, wherein the first bus comprises a forwarded clock and wherein the second bus comprises an embedded clock.

17. The system of claim 15, wherein the first bus comprises a higher data bandwidth than the second bus.

18. The system of claim 15, wherein the extension circuitry comprises a training state machine and pattern generator to calibrate a tester coupled with the external interface.

19. The system of claim 15, wherein the extension circuitry comprises latency fixing logic to align a plurality of data lanes to a reference time.

20. The system of claim 15, wherein the extension circuitry comprises multiplexers to selectively extend the first bus to the external interface.
